(19) United States
(12) Patent Application Publication
(10) Pub. No.: US 2026/0178546 A1
(43) Pub. Date: Jun. 25, 2026

(54) Methods, Systems And Computer Program Products For Synchronising Data Between Multiple Applications

(71) Applicant: Xero Limited, Te Aro, Wellington (NZ)

(72) Inventors: Benjamin Gemperline, Te Aro, Wellington (NZ); Zachary Wolf, Te Aro, Wellington (NZ); Jason Kassay, Te Aro, Wellington (NZ); Matthew Green, Te Aro, Wellington (NZ); Benjamin Pope, Te Aro, Wellington (NZ)

(21) Appl. No.: 19/127,892

(22) PCT Filed: Nov. 9, 2023
(86) PCT No.: PCT/NZ2023/050126

§ 371 Date: May 7, 2025

(30) Foreign Application Priority Data
Nov. 10, 2022 (AU) 2022903361

(51) Int. Cl. G06F 16/178; G06F 40/18

(52) U.S. Cl. CPC G06F 16/178; G06F 40/18

(57) ABSTRACT

Methods and systems synchronize data between multiple applications and devices. A method comprises determining a set of data locations of a first document format of a first document generated by a first application, transmitting a first application synching configuration comprising the set of data locations to a synching server; and responsive to determining a changed value at a data location, transmitting a first notification, comprising the changed value and one or more of: (i) the data location; and (ii) a corresponding data location of a second document format of the second document generated by a second application, to the synching server.

### CROSS-REFERENCE TO RELATED APPLICATIONS

The present application claims priority from Australian Provisional Patent Application No 2022903361 filed on 10 Nov. 2022, the contents of which are incorporated herein by reference in their entirety.

### TECHNICAL FIELD

Embodiments generally relate to methods, systems and computer program products for synchronising data between multiple applications and multiple devices.

### BACKGROUND

Synchronisation across multiple devices or servers with multiple users is an important aspect of the information age, as it allows users to readily access their data and share it with others.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to a method comprising: determining a set of data locations of a first document format of a first document, the first document generated by a first application being executed by one or more first processors, and the first document being presented in a first application window of a first user interface of a first user device; transmitting a first application synching configuration to a synching server, wherein the first application synching configuration comprises the set of data locations to be synchronised with a corresponding set of data locations of a second document format of a second document generated by a second application different to the first application; and responsive to determining a changed value at a data location of the set, transmitting a first notification to the synching server, wherein the first notification comprises the respective changed value and one or more of: (i) the data location; and (ii) a corresponding data location of the second document format of the second document.

In some embodiments, the method further comprises: responsive to receiving a second notification from the synching server, the second notification comprising an updated value, and one or more of: (i) an identified data location of the first document format; and (ii) an identified data location of the second document format, replacing a current value at the identified data location with the updated value.

In some embodiments, the one or more first processors are one or more first processors of the first user device. In further embodiments, the one or more first processors are one or more first processors of a first application server in communication with the first user device.

In some embodiments, the first application is configured to present, on one or more user interfaces of respective user devices including the first user device, the generated first document, and wherein responsive to receiving user input via a user interface of the one or more user interfaces, the user input comprising a change in a value at a data location of the first document, reflecting the change in value at the data location in the generated first document presented on each of the one or more user interfaces of the respective user devices.

In some embodiments, the data locations correspond with data fields of the first document format. In some embodiments, the method further comprises: receiving a first subscription request from the synching server, wherein the first subscription request comprises a subscription for notification of a change in any of the data locations of the first application synching configuration.

In some embodiments, the method further comprises providing a widget in the first application window of the user interface, the widget comprising a first user interactive component to allow the user to select the set of data locations of the first application synching configuration.

In some embodiments, the method further comprises embedding an element within the first application window, the element configured to display the second document generated by the second application, and the element comprising a second user interactive component to allow the user to select the set of data locations of the second document.

In some embodiments, the method further comprises determining a synching map, the synching map comprising the first application synching configuration comprising the set of data locations of the first document format and the corresponding set of data locations of the second document format with which they are to be synched; determining, from the synching map, the corresponding data location of the second document format associated with the data location of the first document format associated with the changed value.

In some embodiments, the method further comprises transmitting a request to the synching server to synchronise the first document with the second document; and receiving, from the synching server, a unique identifier for the first document. In further embodiments, the method further comprises: responsive to a user reopening the first document, transmitting the unique identifier to the synching server; and receiving a current state of the syncing map.

Some embodiments relate to a method comprising: determining a synching map, the synching map comprising a set of data locations of a first document format, and for each of the plurality of data locations, a corresponding data location of a second document format, wherein the first document format is associated with a first document generated by a first application, and the second document format is associated with second document generated by a second application, and wherein the first application is different to the second application; determining a first application synching configuration, the first application synching configuration comprising a set of data locations of the first document format; and responsive to determining a changed value at a data location of the set of data locations in the first document, transmitting a first notification to the second application, wherein the first notification comprises the changed value and at least one of: (i) data location of the first document; and (ii) a corresponding data location of the second document.

In some embodiments, the method further comprises, responsive to determining the changed value at the data location of the set in the first document, determining, from the synching map, the corresponding data location of the second document, wherein the first notification comprises the corresponding data location determined from the synching map.

In some embodiments, the method further comprises, responsive to determining a changed value at a data location in the second document, the data location corresponding to a data location of the set in the first document, transmitting a second notification to the first application, wherein the second notification comprises the changed value and at least one of: (i) the corresponding data location of the first document associated with the changed value; and (ii) the data location of the second document associated with the changed value.

In some embodiments, the method further comprises, responsive to determining the changed value at the data location of the set in the second document, determining, from the synching map, the corresponding data location of the first document, wherein the second notification comprises the corresponding data location determined from the synching map.

In some embodiments, the method further comprises determining an updated application synching configuration, the updated application synching configuration comprising an updated set of data locations of the first document format or the second document format; and responsive to determining a changed value at a data location of the set in the first document or the second document, transmitting a third notification to the first or second application, respectively, wherein the third notification comprises the changed value and at least one of: (i) the data location of the first or second document; and (ii) and the corresponding data location of the first or second document associated with the changed value.

In some embodiments, the method further comprises determining, from the synching map, the corresponding data location of the first or second document. In some embodiments, determining an updated application synching configuration comprises receiving the updated application synching configuration from the first application or the second application. In further embodiments, the first and second applications are different types of applications.

In some embodiments, determining the first application synching configuration comprises determining one of a plurality of predefined application synching configurations, each predefined application synching configuration comprising a different set of data locations of the first document format.

In some embodiments, the method further comprises transmitting a subscription request to the first application and/or the second application, wherein the subscription request comprises a subscription for notification of a change in any of the data locations associated with the first application synching configuration.

In some embodiments, the method further comprises transmitting the first application synching configuration to the second application; and responsive to a changed value at a data location of the set in the second document being determined by the second application, receiving a message comprising the data location and the changed value.

In some embodiments, transmitting the first application synching configuration to the second application comprises transmitting the synching map including the first application synching configuration to the second application. In some embodiments, the method further comprises: storing, in an event log, information about changed values at data locations of the set. In further embodiments, the first and/or second application is an accounting application and the data corresponds to accounting data.

In some embodiments, the first and/or second document comprises a spreadsheet, wherein the spreadsheet comprises multiple rows and multiple columns, the multiple rows and multiple columns defining a plurality of cells, and each cell corresponding to a data location of the first and/or second document.

In some embodiments, the set of data locations of the first document format or the second document format is a subset of all data locations of the first document format or the second document format respectively. In further embodiments, the method further comprises: determining the synching map or determining the first application synching configuration using a user input via a user interface of the one or more user interfaces.

Some embodiments relate to a system comprising: one or more processors; and memory comprising computer executable instructions, which when executed by the one or more processors, cause the system to perform any one of the described methods.

Some embodiments relate to a computer-readable storage medium storing instructions that, when executed by a computer, cause the computer to perform the method of any one of the described methods.

### BRIEF DESCRIPTION OF THE DRAWINGS

Various ones of the appended drawings merely illustrate example embodiments of the present disclosure and cannot be considered as limiting its scope.

FIG. 1 is a block diagram of a system for synchronising data between multiple applications, according to some embodiments;

FIG. 2a is a process flow diagram of a method of data synchronisation between multiple applications, the method being implemented by a user device or an application server in communication with a synchronisation server, according to some embodiments;

FIG. 2b is a process flow diagram of a method of data synchronisation between multiple applications, the method being performed by a synchronisation server in communication with a user device or an application server, according to some embodiments;

FIG. 3 is an example of a user interface for data synchronisation between a first application and a second application, according to some embodiments; and

FIG. 4 is an example of a system for data synchronisation between a first user interface and a second user interface, according to some embodiments.

### DETAILED DESCRIPTION

Embodiments generally relate to methods, systems and computer program products for synchronising data between multiple applications. Some embodiments allow for synchronisation of a selectable set of data, such as a subset of data, from one application to another, and optionally vice versa. Some embodiments allow for the automatic synchronisation between different application types.

It is an advantage to transmit a first notification to a synching server to be able to monitor or watch specific data locations for changes in the values at the data locations. This allows subscribers of the specific data locations to be notified when values at the data locations are changed, which can be used to replace or update values on a separate document. It is a further advantage, as the first application may be executed on multiple devices or servers, in which data is able to be synched across the multiple devices or servers via the synching server.

It is a further advantage to transmit a first notification to a first or second application responsive to determining a changed value at a data location in the first document or the second document, to enable data synchronisation between the first and second document. Receiving the first notification may be used to make changes in the first or second document accordingly. It is a further advantage if the first and second application are different application types, as it allows for interoperability between the two applications.

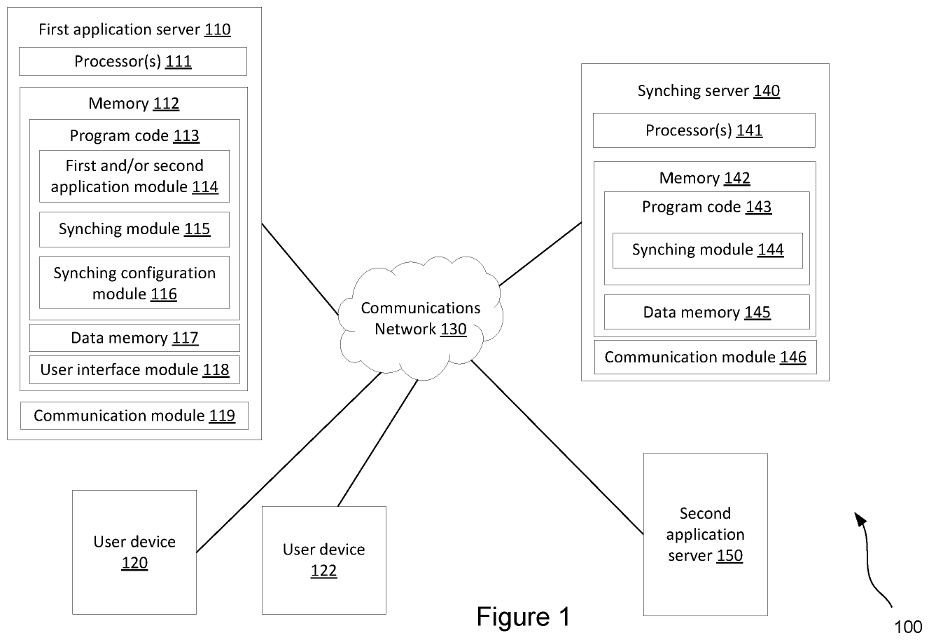

FIG. 1 illustrates a block diagram of a system 100 for synchronising data between multiple applications, according to some embodiments. The system 100 comprises a first application server 110, which includes the hardware and software necessary to provide a first application and/or a second application. In some embodiments, first application and/or a second application provided by the first application server 110 may be accessible to a first user device 120 via a communications network 130, such as the Internet. First user device 120 may be an end-user computing device such as a desktop computer, a laptop computer, a mobile device or a tablet device for example. System 100 may further comprise a second application server 150, and in some embodiments, further additional application servers (not shown), which may comprise the same or similar hardware and software as the first application server 110. As such, second application server 150 may have the exact same or similar capabilities and functionality as first application server 110. Similarly, system 100 may comprise a second user device 122, and in some embodiments further additional user devices (not shown).

First application server 110 comprises at least one processor 111 and memory 112. Processor(s) 111 may include an integrated electronic circuit that performs the calculations such as a microprocessor, graphic processing unit, for example. In some embodiments, first application server 110 may be implemented as a distributed system comprising multiple server systems configured to communicate over a network to provide the functionality of first application server 110.

Memory 112 may comprise both volatile and non-volatile memory for storing executable program code, or data. Memory 112 comprises program code 113 which when executed by the processor(s) 111, provides the various capabilities of the first application server 110. The block diagram of FIG. 1 illustrates some of the modules stored in memory 112, which when executed by the processor(s) 111 of the first application server 110, perform the functionality of the first application server 110 as described below.

In some embodiments, program code 113 of memory 112 may comprise first and/or second application module 114, which comprises program code of a first and/or second application, respectively, which when executed by the processor(s) 111, causes the first application server 110 to run the first and/or second program. For example, the first application of the first application module 114 may be configured to generate a first document. The first document may be presented in a first application window of a first user interface of a first user device.

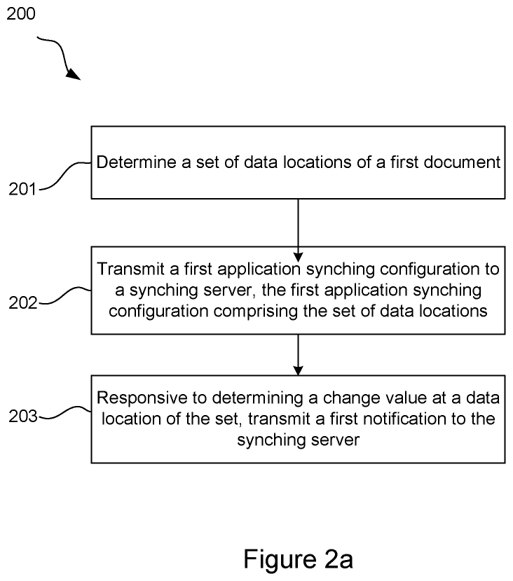

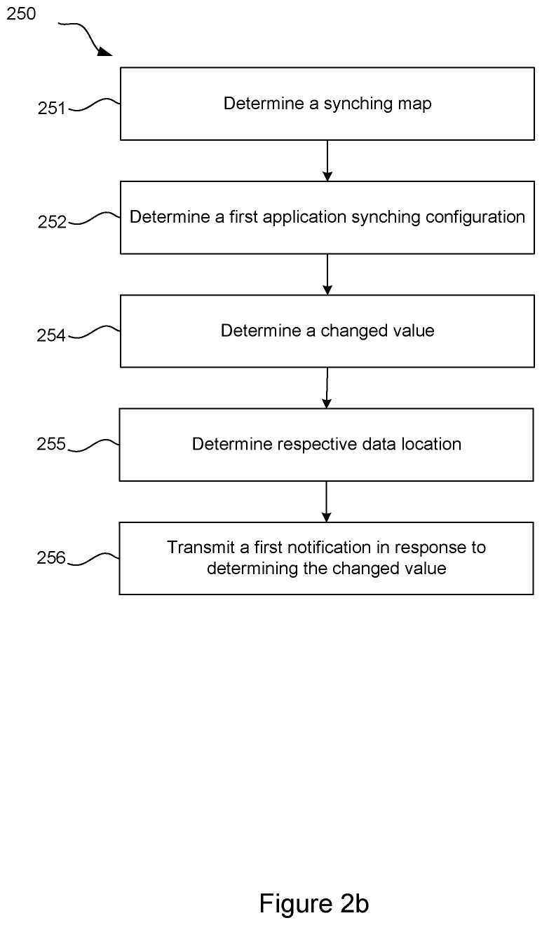

In some embodiments, program code 113 comprises an application synching module 115 for facilitating the synching of data between two applications. The application synching module 115 comprises computer executable code which when executed by the processor(s) 111 causes the first application server 110 to perform method 200. For example, method 200 of FIG. 2a may be understood as a blueprint for a software program and may be implemented step-by-step, such that each step in FIG. 2a is represented by a function in a programming language, such as C++ or Java. As such, processor(s) 111 may execute this program code, to perform the method 200 of FIG. 2a, as described below. In some embodiments, the application synching module 115 comprises an application, such as an “Add-In” or “Plug In”.

Application synching module 115 of memory 112 may comprise a synching configuration module 116, which comprises program code which, when executed by the processor(s) 111, causes the first application server 110 to determine a first application synching configuration. In some embodiments, synching configuration module 116 comprises program code which, when executed by the processor(s) 111, causes the first application server 110 to determine a set of data locations of a first document format of a first document. For example, the first document may be generated by the first application of the first application module 114 being executed by processor(s) 111.

In some embodiments, the application synching module 115 may be configured to provide or generate the second application within an element (not shown) to be deployed or embedded within the first application window of the first user interface. For example, the element may be an inline frame or iframe, such as an HTML element. Accordingly, the second application may be used to include or display contents from an external source, such as from a second application server 150. In some embodiments, a user may be required to provide user credentials to access a user account and documents associated with that user account, which can be displayed within the element. In some embodiments, the synching configuration module 116 may be configured to cooperate with the second application within the element (not shown) embedded within the first application window to determine a synchronisation mapping or synching map between the first and second applications.

First application server 110 comprises data memory 117, which may be a non-transitory computer-readable medium, such as a hard drive, a solid state disk or CD-ROM. Data memory 117 may store data such as one or more application synching configurations, one or more synching maps, log data comprising multiple event logs indicative of information about changed values at data locations of the set, and/or information indicative of set of data locations such as various data fields, for example. The application synching configuration(s) and/or synching map(s) may be stored on data memory 117 as JavaScript Object Notation (JSON) files or a similar/equivalent format, for example. In some embodiments, event logs associated with notified or notifiable events may be stored on data memory 117 as log data in a log file in the Common Log Format, also known as the NCSA Common log format, or a similar/equivalent format.

While in this embodiment of system 100, first application server 110 comprises data memory 117, system 100 may comprise a database (not shown), which may be implemented using a relational database or a non-relational database or a combination of a relational database and a NoSQL database. For example, the database may be a key-value database or a key-value pair storage medium, which stores data as a collection of key-value pairs in which a key may serve as a unique identifier. The database may be implemented as a distributed system to meet potential scalability requirements of the first application server 110. First application server 110 may access the database directly or via the communications network 130. In this embodiment, the database may perform the role of data memory 117, as such, the database may have the same capabilities and functionality as data memory 117.

Processor(s) 111 may receive data through all these interfaces, which includes memory access of volatile memory, such as cache or RAM, or non-volatile memory, such as an optical disk drive, hard disk drive, storage server or cloud storage. System 100 may further be implemented within a cloud computing environment, such as a managed group of interconnected servers hosting a dynamic number of virtual machines.

It is to be understood that any receiving step may be preceded by the processor(s) 111 determining or computing the data that is later received. For example, processor(s) 111 may store an application synching configuration and/or a synching map on data memory 117, such as on RAM or a processor register. Processor(s) 111 then requests the data from the data memory 117, such as by providing a read signal together with a memory address. The data memory 117 provides the data as a voltage signal on a physical bit line.

Memory 112 may also comprise a user interface module 118 to allow a user to interact with the first application server 110, and/or the second application server 150. For example, the user interface module 118 may allow users to interact with a first document presented in the first application window of the first user interface, and in some embodiments, for example, to interact with a second document or a second application via element (not shown) embedded within the first application window. In some embodiments, a user may interact with the first document and specify a set or subset of data locations of a first document format of a first document, thereby determining a synching configuration. In some embodiments, a user may interact a first application window of a first user interface a select a plurality of data locations of a first document format, and for each of the plurality of data locations, select or otherwise allocate or assign a corresponding data location of a second document format, thereby determining a synching map. The synching map may therefore comprise a synching configuration (i.e., a set of data locations in the first document) and a corresponding set of data locations in the second document to which a data location of the synching configuration is to be mapped. The corresponding data locations of the second document may be determined from the second application or second document as may be presented in the element (not shown), for example, by engaging with a user selectable option.

In some embodiments, one or more of the data locations of the set of data locations of a first document may be mapped to two or more different locations of a second document. For example data location A in a first document may be mapped to both data locations X and Y in a second document.

In some embodiments, one or more of the data locations of the set of data locations of a first document may be mapped to two or more different documents, generated by the same or different applications.

First application server 110 may also be configured to connect or be connected to a monitor or display, which is in communication with the user interface module 118, in which a user of first application server 110 may interact with. The user interface, as generated by the user interface module 118, may be configured to accept input (via buttons or text fields etc.) from the user, via a touch screen or a device attached to first application server 110 such as a keyboard or computer mouse. These devices may also include a touchpad, an externally connected touchscreen, a joystick, a button, and a dial.

In some embodiments, first application server 110 may be configured to receive input for first user device 120 via the communications network 130. For example, user interface module 118 may generate a user interface on user device 120 via the communications network 130. A user may then interact with the user interface on first user device 120, and the user input may be communicated to user interface module 118 via the communications network 130. In some embodiments, first user device 120 may be in direct communication with first application server 110, rather than in communication via communications network 130.

First application server 110 further comprises a communication module 119 which may comprise a network interface to facilitate communications with components of the system 100 across the communications network 130, such as the first user device 120. The communication module 119 may further comprise a combination of network interface hardware and network interface software suitable for establishing, maintaining and facilitating communication over a relevant communication channel.

In some embodiments, communication module 119 may comprise program code, such as synching modules 115, which, when executed by the processor(s) 111, causes the first application server 110 to transmit an application synching configuration and/or synching map to synching server 140 and/or receive notifications or subscription requests from synching server 140. Communication module 119 may facilitate communications with other applications servers, user devices, and/or the synching server, as required.

First application server 110 may further comprise an I/O port (not shown) that communicates with communication module 119 and enables communication module 119 to communicate other devices on the communications network 130, such as by using a Wi-Fi network according to IEEE 802.11. The Wi-Fi network may be a decentralised ad-hoc network, such that no dedicated management infrastructure, such as a router, is required or a centralised network with a router or access point managing the network.

The I/O port may be single entity or multiple entities, however, it is to be understood that any kind of data port may be used to receive data, such as a network connection, a memory interface, a pin of the chip package of processor(s) 111, or logical ports, such as IP sockets or parameters of functions stored on program code 113 and executed by processor(s) 111. The parameters of functions may be stored on data memory 117 and may be handled by-value or by-reference, that is, as a pointer, in the source code.

In some embodiments, first user device 120 may have the hardware and software necessary to perform the same functions as first application server 110. For example, the first application and/or second applications may be hosted and executed locally on a user's device.

For example, first user device 120 may comprise one or more processor(s), memory and communication module, wherein the memory comprises program code, data memory, and/or user interface module. The program code may comprise a first and/or second application module 114, application syncing module 115 and/or a synching configuration module 116. As such, first user device 120 may be configured to perform the method of any of the described embodiments.

System 100 may further comprise synching server 140, which may comprise one or more processor(s) 141 and memory 142. Memory 142 may comprise program code 143 and data memory 145, and a communication module 146. Additionally, synching server 140 may comprise one or more I/O ports, and may be in communication with a database over the communications network 130, rather than data memory 145. In that respect, synching server 140 may have similar functionality to first application server 110.

Program code 143 of memory 142 may comprise synching module 144, which comprises program code which, when executed by the processor(s) 141, causes synching server 140 to facilitate the synching of data between two applications. Synching module 144 may comprise computer executable code, which when executed by the processor(s) 141, causes the synching server 140 to perform method 250 of FIG. 2b, described below. For example, method 250 may be understood as a blueprint for a software program and may be implemented step-by-step, such that each step in FIG. 2b is represented by a function in a programming language, such as C++ or Java. As such, processor(s) 141 may execute this program code, to perform the method 250.

More specifically, synching module 144 may comprise program code which, when executed by the processor(s) 141, causes synching server 140 to determine a synching map. The synching map may comprise a plurality of data locations of a first document format, and for each of the plurality of data locations, a corresponding data location of a second document format.

Synching module 144 may comprise program code which, when executed by the processor(s) 141, causes synching server 140 to determine, from the synching map, corresponding data locations of the second document format for each of the set of data locations of the first document format.

Synching server 140 comprises a communication module 146, which comprises program code which, when executed by the processor(s) 141, causes synching server 140 to transmit notifications and/or requests to one or more applications, such as a first and/or second application, deployed on the application server(s) or user device(s).

Communication module 146 may comprise program code which, when executed by the processor(s) 141, causes synching server 140 to receive notifications, application synching configuration(s) and/or synching map(s) from the application server(s) or user device(s). In some embodiments, synching module 144 may be configured to provide the first application server 110, the second application server 150, the first user device 120, and/or further user devices with a copy of a current state of the synching map, for example, when the synching map has been updated by another application server and/or user device, or when a document associated with the synching map has been opened or accessed, such as re-opened or re-accessed.

Synching server 140 may be configured to facilitate data synchronisation between multiple applications. For example, the synching server 140 may be configured to receive and store application synching configurations or synching maps, for example, as received from application server(s) 110, 150 and/or user device(s) 120, 122. This may include updated application synching configuration(s) and/or updated synching map(s). Synching server 140 may be configured to monitor for changes in data values at a set of data locations of application synching configuration(s). For example, synching server 140 may be configured to receive notifications from devices in the communications network 130, such as first application server 110, second application server 150, first user device 120 and/or second user device 122 when change(s) in value(s) are determined to have occurred. The notification(s) may comprise an identified data location of a document format of a document generated by an application, and an updated value. For example, the synching server 140 may subscribe to receive event notifications when one or more values at specified data locations of an application synching configuration or synching map change.

Synching server 140 may be configured to determine, from the synching map, a corresponding data location within a second document generated by a second application to which the change in value is to be mapped. Synching server 140 may transmit the change in value and the determined corresponding data location to the user device(s) 120, 122 and/or application server(s) 110, 150 responsible for generating the second document, which may cause the change in value to be reflected in the second document. In some embodiments, the first application server or first user device may determine the corresponding data location of the second document based on a locally stored current state of the synching map and may transmit this information along with the changed value at the location of the first document to synching server 140. In such embodiments, synching server 140 may transmit the changed value and data location in the second document to the second application without consulting the synching map.

In some embodiments, communication module 146 of synching server 140 may be configured with a message queue service, in which notifications and/or messages may be transmitted using this message queue service. In some examples, the message queue service may be a publish-subscribe service. These notifications and/or messages may be indicative of changed values that occur on one device and may be transmitted to other devices on communication network 130. As such, the message queue service may form part of the synching mechanism of synching server 140.

In some examples, application server(s) 110, 150 and/or user device(s) 120, 122 may be subscribed to the message queue service (such as by receiving a subscription request from the message queue service) and each subscribed device may receive messages that are published by the message queue service. In some embodiments, the first application or the second application running on application server(s) 110, 150 or user device(s) 120, 122 may be subscribed to the message queue service. For example, only the second application may be subscribed and, as a result, messages published by the message queue service may be received by the second application, but not by the first application.

In some embodiments, multiple instances of the first and/or second application by being running of application server(s) 110, 150 and/or user device(s) 120, 122 and each instance may be subscribed to the message queue service. For example, an instance of the first application may be running of first application server 110 and another instance of the first application may be running of second application server 150, however, in this example, only the instance on first application server 110 may be subscribed to the message queue service. As such, only the instance on first application server 110 receives the notifications/messages published by the message queue service. In some embodiments, a user of a device may select the other devices that are intended to receive notifications by selectively subscribing and/or unsubscribing devices to the message queue service.

As an example, responsive to determining a changed value at a data location, first application server 110 may transmit a first notification to the synching server. If user devices 120 and 122 are subscribed to the message queue service, then, in response to synching server 140 receiving the first notification, synching server 140 may (via the message queue service) transmit the first notification to user devices 120 and 122. In some embodiments, in response to receiving the first notification, synching server 140 (via the message queue) may transmit a notification that is associated with, but different to, the first notification. For example, this notification may be used inform user devices 120 and 122 that a value was changed on first application server 110, however the notification may not comprise the respective changed value and one or more of: (i) the data location; and (ii) a corresponding data location of the second document format of the second document.

In some examples, the described embodiments of the method and system may be implemented in a Google Firebase environment. As such, synching server 140 may be a server service offered through the Google Firebase environment, such as Cloud Firestore, for example. In some examples, the message queue service may be implemented in the Google Firebase environment using Firebase Cloud Messaging service. In another example, the message queue service may implemented using a network messaging protocol. For example, the network messaging protocol may be the Message Queue Telemetry Transport (MQTT) protocol.

In some embodiments, first application server 110 and second application server 150 may both run an instance of the first and second application, each application having a document format of a document that is generated by the respective application. As an example, there may be four documents between the first application server 110 and the second application server 150. In an example, an application synching configuration and/or a synching map may be common for all applications and the synching server 140 may be responsible for synching data across all applications using a synching map that maps data locations between all four documents generated by the respective four applications.

In some embodiments, data memory 145 may store one or more application synching configurations, one or more synching maps, and/or event log data comprising one or more event logs indicative of information to which the synching server 140 subscribes, such as changed values at data locations of the set, and/or information indicative of set of data locations such as various data fields. The application synching configuration(s) and/or synching map(s) may be store on data memory 145 as JavaScript Object Notation (JSON) files or a similar/equivalent format, for example.

For example, when synching server 140 transmits a first notification to the first or second application, responsive to determining a changed value at a data location of the set in the first document or the second document, synching server 140 may store the first notification in an event log. The event log may comprise the data location of the first and/or second document and the respective changed value. The event log may comprise information about the first and/second application, the first and/or second document format, the first and/or second document, a time stamp indicative of the time when the event was logged and/or the IP address the application server(s) or user device(s) associated with the transmission. Further, the event log may comprise information about the current value at the data location, before the value is changed. In some examples, processor(s) 141 may store the event log as log data in a log file in the Common Log Format, also known as the NCSA Common log format. By maintaining or recording all events or changes to the documents in an event log, states of the document(s) at any point in time may be determined allowing a chain or trail of edits to be determined, and corrections made if desired, to revert the state of a document to a prior state.

In some embodiments, the synching map(s) may be stored on application server(s) 110, 150 and synching server 140. In an example, there may be a “master” synching map that is stored on synching server 140 that is used by application server(s) 110, 150 as a source of truth. As such, application server(s) 110, 150 may receive and store a copy of the “master” synching map from synching server 140 and may use it for local synchronisation of data between a first document of a first application and a second document of a second application. In some examples, first application server 110 and second application server 150 may both store a copy of the “master” synching map and may use it for local synchronisation of data between the first and second document on each respective sever. In other words, data synching on one application server may be irrespective of data synching on the other server.

In some embodiments, event log(s) may be stored on application server(s) 110, 150 and synching server 140. For example, there may be a “master” event log file stored on synching server 140 that is transmitted to each application server. In some embodiments, each application server may create event logs comprising information about changed values during local synchronisation on the respective server. The application servers may transmit these event logs, in the form of a notification for example, to synching server 140 and synching server 140 may compile these event logs into the “master” event log and store it on data memory 145.

In some embodiments, the application synching configuration and/or synching map stored locally on application server(s) 110, 150 may be changed, for example, by receiving user input. Synching server 140 may receive the changed application synching configuration and/or synching map and may update the “master” synching map according to the changed application synching configuration or changed synching map, respectively. For example, application server(s) 110, 150 may transmit the changed application synching configuration and/or synching map to synching server 140 in response to determining a change in the application synching configuration and/or synching map. Synching server 140 may transmit a notification to each application server that have received the original “master” synching map, the notification may comprise information indicative of the changed synching map. Synching server 140 may also transmit a copy of the new “master” synching map to each application server that received the original “master” synching map.

FIG. 1 is one example of a configuration of system 100. However, system 100 is not strictly limited to this configuration and this may be one possible embodiment of system 100. In some embodiments, system 100 may comprise any number of application servers, synching servers, user devices and/or databases.

FIG. 2a illustrates a process flow diagram of method 200 of data synchronisation between multiple applications. In some embodiments, method 200 may be performed by one or more processors of a computing device in communication with a synching server across a communications network. In some embodiments, the processor(s) are one or more first processors of the first user device. In other embodiments, the processor(s) are processor(s) 111 of first application server 110, which is in communication with first user device(s) 120, 122 and synching server 140, for example, across communications network 130.

The first document may be generated by a first application being executed by the processor(s) 111. The first document may be presented in a first application window of a first user interface of the first user device. In an example, the first application may be a word processing application, such as Microsoft Word, and the data location may be the location within the Microsoft Word document, such as a location within a particular word line.

In some embodiments, the first document comprises a spreadsheet. The spreadsheet may comprise multiple rows and multiple columns, the multiple rows and multiple columns defining a plurality of cells, each cell corresponding to a data location of the first document. As such, the first application may be a spreadsheet application, such as Microsoft Excel, and the first document may be a workbook that corresponds to a spreadsheet program file created in Microsoft Excel. Further, the first document format may be a spreadsheet format.

In some embodiments, on instigation of the first application to initially create the first document, the processor(s) 111 of first application server 110 or user device 120 transmits a notification or request to synching server 140 indicating that a linking or connection between the first application and a second application is requested. Synching server may generate a globally unique identifier (GUID) or a universally unique identifier (UUID) for the first document. In some embodiments, the unique identifier may be used as a “synchronisation key”. Synching server 140 may transmit the unique identifier to application server(s) 110, 150, which may cause application server(s) 110, 150 to store the unique identifier, for example, as metadata of the first document. In some embodiments, the first application provides a user selectable option to allow the user to instigate the transmission of the notification or request to synching server 140 indicating that linkage or synchronisation between the first application and a second application is requested.

The first application server 110 or user device 120, for example, executing synching configuration module 116, determines 201 a set or subset of data locations of a first document format of a first document. The first application server 110 or user device 120 may receive user input from the first user device 120, 122. The user input may specify the data locations of the first document format of a first document. For example, if the first document comprises a spreadsheet, the user input may be indicative of cells of the spreadsheet. Hence, the set or subset of data locations of the first document format of the first document may be the cells that a user, associated with the first user device 120, 120, selects to monitor or watch for changes in the data values within those cells. The user may select the cells of the spreadsheet that is presented to the user via a first application window of a first user interface of a first user device.

In some embodiments, the data locations correspond with data fields of the first document format. For example, the user input may specify the data locations by specifying the data fields. The data fields may be indicative of data location identifiers, such as a cell ID. For example, if the first application is Microsoft Excel, the user may specify the data locations by inputting “A1, B1, C1”, which would correspond to the first three cells of the first row of the spreadsheet.

The first application server 110 or user device 120, for example, executing application synching module 115, transmits, at 202, a first application synching configuration to a synching server 140. The first application synching configuration comprises the set of data locations. In some embodiments, the first application synching configuration may be stored as a JavaScript Object Notation (JSON) file generated by first application and the JSON file may contain the set of data locations, by specifying the data fields or data location identifiers. In some embodiments, the first application comprises an user interface element (such as an application synching configuration button presented in the first application window) that the user may interact with and, upon the user interacting with the element, processors(s) 111 generates a JSON file corresponding to the first application synching configuration. More specifically, the user may select data locations to be monitored or watched and, upon interacting with the user interface element, the processor(s) 111 generates a JSON file corresponding to the first application synching configuration, which contains or comprises the data fields or data location identifiers to specify the data locations that the user has selected. In other embodiments, processor(s) 111 may generate the first application synching configuration automatically without the user interacting with the user interface element. In some embodiments, the first application server 110 or user device 120 transmits, at 202, a synching map comprising the application synching configuration and corresponding data locations of the second document to the synching server 140.

It may be advantageous to determine and transmit the first application synching configuration and/or the synching map to the synching server 140, as the user can select the data locations to be monitored or watch for synchronisation with the second document, then close the first application or restart the first user device, for example, without having to reselect the data locations to monitor or watch, because the synching server 140 already has the configuration and can use it to facilitate synchronisation between applications once the applications are reopened or reactivated. For example, when a user reopens a first document and opens or activates the application synching module 115, the application synching module 115 sends the GUID of the first document to synching server 140. The synching server 140 determine synching map(s) associated with the first document and transmits the determined synching map(s) to the application synching module 115 such that the application synching module 115 has access to a current state of the synching map(s). The synching server 140 subscribes to event notifications regarding changes at the data locations of the first documents in accordance with the synching map(s). This may be particularly advantageous if many data locations are selected for monitoring and synching, as it may be time consuming activity. This is also an advantage if the first user device 120, 122 or the first application were to crash unexpectedly.

In some embodiments, responsive to the application synching module 115 or synching server 140 determining that a particular data location of the second document is already synchronised with another data location of the first document or of another document, such that the mapping proposed by the user would interfere or collide or override the existing mapping, a message may be provided to the user, for example, via the user interface, to notify the user of the potential problem. In some embodiments, the user may be prevented from setting that particular mapping. In some embodiments, the user may be provided with a user interactive option to proceed with the mapping regardless.

Responsive to a changed value at a data location of the set being determined, the first application server 110 or user device 120 for example, executing application synching module 115, transmits, at 203, a first notification to the synching server 140. The first notification may comprise the data location and the respective changed value. In some embodiments, the first application server 110 or user device 120 may use the first application synching configuration to determine the set of data locations to monitor and watch for changes in the value at these data locations. In some embodiments, the synching server 140 may use the first application synching configuration to determine the set of data locations to which to subscribe to for event notifications of changes in value at the data locations.

In some embodiments, the first application server 110 or user device 120 may determine a changed value at a data location that is not within the set of data locations specified by the first application synching configuration. If the data location is not a data location of the set of data locations, first application server 110 or user device 120 will not transmit a notification to the synching server 140, responsive to determining this changed value. In some embodiments, changes at any or all data locations may be communicated to a second instance of the first application, for example as may be realised on the first user device, such as user device 120 with reference to FIG. 1, or a second different user device, such as user device 122 with reference to FIG. 1.

In some embodiments, the first application may be configured to present, on one or more user interfaces of respective user devices including the first user device or the second user device, the generated first document. In some embodiments, responsive to receiving user input via a user interface of the one or more user interfaces, the user input comprising a change in a value at a data location of the first document, reflecting the change in value at the data location in the generated first document presented on each of the one or more user interfaces of the respective user devices. In other words, making a change in the value at a data location on the first user device would cause the same change to be made to the value at the data location on the second user device. Examples of such include where multiple users access the same first document from different user devices. Examples of such include Microsoft Excel Online and Google Sheets, where users can contribute collaboratively on the same document, and the changes to the document made by one user are reflected in the document of all other users, thereby keeping the documents synched across all devices.

In some embodiments, the first application server 110 or user device 120 may receive a second notification from the synching server 140. The second notification may comprise an identified data location of the first document format and an updated value. The second notification may comprise an identified data location of the second document format and an updated value, in which case the first application server 110 or user device 120 may consult a locally stored synching map to determine the corresponding data location of the first document. In some embodiments, responsive to receiving the second notification from the synching server, the processor(s) 111 may replace a current value at the identified data location with the updated value. This may occur where data locations of a second document generated by a second and different application are to be synchronised with data locations of the first document. For example, one or more second processors of a second user device or a second application server may execute the second application and the second processor(s) may transmit the second notification to the synching server in response to a change in value at a data location of a second document corresponding to the data location of the first application synching configuration.

In some embodiments, the first application server 110 or user device 120 may receive a first subscription request from synching server 140. For example, the first application server 110 or user device 120 may receive the first notification in response to the first application server 110 or user device 120 transmitting the first application synching configuration or synching map to synching server 140. The first subscription request comprises a subscription for notification of a change in value at the data locations of the first application synching configuration. Accordingly, in some embodiments, should any changes in value occur at the set of data locations, the first application server 110 or user device 120 transmits a notification automatically to synching server 140. In other embodiments, the processor(s) 141 of synching server 140 monitors or watches for changes or intercepts changes in value at the data locations of the first application synching configuration and responsive to determining a change, transmits a notification to the second application server 150 or user device 122 hosting the second application with which the first document is to be synched.

In some embodiments, upon receiving the transmitted first application synching configuration or synching map from the first application server 110 or user device 120, synching server 140 may process the first application synching configuration or synching map. In this embodiment, processing, by synching server 140, the first application synching configuration or synching map may comprise determining whether the application server 110, 150 or user device 120, 122 is eligible to be synched with a document of another application. Eligibility may be contingent on whether the application server 110, 150 or user device 120, 122 is configured or compatible, or whether the device has permission or is on an approved list of devices, such as a whitelist, for example.

In some embodiments, the first application server 110 or user device 120 provides an element or widget in the first application window of the user interface. The widget may comprise a user interactive component to allow the user to select the set of data locations of the first application synching configuration. As discussed above, in some embodiments, the second application may be generated within an element (not shown), such as an iframe, to be deployed or embedded within the first application window of the first user interface. The element may be used in conjunction with the widget to allow the user to select the set of data locations of the first application and the corresponding data locations of the second application which may form the synching map.

FIG. 2b illustrates a process flow diagram of method 250 of data synchronisation between multiple applications, according to some embodiments. In some embodiments, method 250 may be performed by one or more processors of a computing system. For example, one or more processors may be processor(s) 141 of synching server 140, which executes synching module 144 stored in memory 142, and is in communication with one or more applications server(s) 110, 150 and/or one or more user devices 120, 122.

In some embodiments, processor(s) 141 of synching server 140 may determine the first and second application to be synchronised by receiving a request for synchronisation from a first application and/or a second application running on application server(s) 110, 150 or user device(s) 120, 122. The first application synching configuration may specify the applications which are to be synchronised. The request may specify an application synching configuration and/or synching map such as a template or preconfigured application synching configuration and/or preconfigured synching map is stored on or accessible to synching server 140 to be used in the synchronisation process. In some embodiments, the request may include a user selected or user specified first application synching configuration and/or synching map. In some embodiments, synching server 140 may receive a separate request comprising a user selected or user specified first application synching configuration and/or synching map.

In some embodiments, processor(s) 141 of synching server 140 may determine the first and second application to be synchronised by receiving a first application synching configuration and/or synching map from the first application running on application server(s) 110, 150 or user device(s) 120, 122. The first application synching configuration and/or synching map may specify the applications which are to be synchronised.

In some embodiments, synching server 140 may determine a unique identifier for the first and second application to be synchronised, for example, in response to receiving an indication from application server(s) 110, 150 or user device that indicates that the user wants to synch a first document of the first application with a second document of the second application. For example, the unique identifier may be a globally unique identifier (GUID), which may also be referred to as a universally unique identifier (UUID). In some embodiments, the unique identifier may be used as a “synchronisation key”. Synching server 140 may store the unique identifier in data memory 145. Synching server 140 may transmit the unique identifier to application server(s) 110, 150, and/or user device(s) which may cause application server(s) 110, 150 and/or user device(s) to store the unique identifier, for example, as metadata of the first document. Subsequently, when the first document is opened on application server(s) 110, 150, and/or user device, the respective device may transmit a notification to synching server 140, wherein the notification comprises the unique identifier. This allows the synching server 140 to determine which synching map and which first and second document on the first and second application, respectively, are to be synchronised.

In some embodiments, as synching server 140 stores the unique identifier that identifies the first document, a copy of the first document may be distributed to another user, or to a different application server/user device. The first document may then be opened on the different application server/user device, which may cause synching server 140 to determine the first document is to be synchronised with a second document of the second application. For example, synching server 140 may identify the first document using the unique identifier by receiving a notification from the different application server/user device, responsive to opening the first document.

In some embodiments, synchronisation may be disconnected between a first and second document of the first and second application, respectively. The disconnection may be the result of synching server 140 receiving user input indicative of the user wanting to disconnect synchronisation or from unexpected termination of the first and/or second application on application server(s) 110, 150, for example. In some embodiments, when the first document is disconnected and then reconnected to the second document, processor(s) 141 may generate a new unique identifier and store the new unique identifier on data memory 145 and may transmit the new unique identifier to application server(s) 110, 150 to identify the first document for synchronisation.

Synching server 140 determines, at 251, a synching map. The synching map comprises a plurality of data locations of a first document format, and for each of the plurality of data locations, a corresponding data location of a second document format. In some embodiments, the synching map comprises mapping data to map data locations of three or more documents. In some embodiments, determining 251 the synching map in method 250 may comprise receiving the synching map from the first and/or second application server 110 and/or from user device 120, 122.

In some embodiments, the first document format is associated with a first document generated by a first application, and the second document format is associated with a second document generated by a second application. The first application is different to the second application. While the first application is different from the second application in these embodiments, both the first and second application may be the same application type, or different application types. For example, both the first and second application may be Microsoft Excel, however the first and second application may be different, in the sense that, processor(s) 111 of application server 110, 150 of user device 120, 122 execute separate instances of Microsoft Excel.

In some embodiments, each of the plurality of data locations of the first document format may be mapped to a data location of a second document format, in the sense that, the mapping is bijective, meaning that there is a one-to-one correspondence between each of the plurality of data locations of the first document format and each data location of the second document format. In other embodiments, one or more data locations of the first document format may map to the same data location of the second document format. In other embodiments, one data location in the first document may map to multiple data locations in the second document.

In some embodiments, the synching map may specify a mapping for all data locations of the first document format to one or more data locations in the second document. In other embodiments, the synching map may specify a mapping for a set, such as a subset, of all data locations of the first document format to one or more data location in the second document.

In some embodiments, first application server 110 may receive user input from the first user device 120 and may create the synching map from the user input. The user input may specify the plurality of data locations of a first document format and may specify the mapping from each of the plurality of data locations of the first document format to one or more corresponding data locations of a second document format. For example, if the first and second application are both instances of Microsoft Excel, the first and second documents thereby being spreadsheets comprising multiple cells, the user may specify a mapping between a data location from the first document to a data location of the second document by selecting a cell in the first document, then selecting a cell in the second document. In another embodiment, the user may specify the mapping by inputting data fields, corresponding to the data location of the first and second document. For example, the user may input the data field “A1” to represent the data location of the first document, then the user may input the data field “B2” to represent the data location in the second document.

In some embodiments, the synching map may be stored as a JavaScript Object Notation (JSON) file generated by first application and the JSON file may contain information corresponding to the set of data locations, such as the data fields or the data locations or data location identifiers. In some embodiments, the first application comprises an user interface element (such as a synching map button presented on a first application window) that the user may interact with and, upon the user interacting with the element, processors(s) 111 of application server(s) 110, 150 or user device(s) 120, 122 generate a JSON file corresponding to the synching map. More specifically, the user may select data locations in the first and second document to define a mapping between the one or more data location and, upon interacting with the user interface element, the processor(s) 111 generates a JSON file corresponding to the synching map, which contains the data field to specify the data locations that the user selected. In other embodiments, processor(s) 111 may generate the synching map automatically without the user interacting with the user interface element.

In some embodiments, determining, at 251, the synching map comprises determining one of a plurality of predefined synching maps. Each predefined synching map may comprise a different plurality of data locations of a first document format, and for each of the plurality of data locations, a different corresponding data location of a second document format. As such, synching server 140 may receive a plurality of predefined synching maps created on application server(s) 110, 150 and/or user device(s) 120, 122.

In some embodiments, there may be one monolithic or “master” synching map stored in data memory 145 of synching server 140 that is used to synch data between the first and second document on each instance of the first and second application running on application server(s) 110, 150 or user device(s) 120, 122. In some embodiments, the “master” synching map may be a combination of individual synching maps that each comprise a different plurality of data locations of a first document format, and for each of the plurality of data locations, a different corresponding data location of a second document format. In some examples, the individual synching map may be the predefined synching maps, as described above.

In some embodiments, determining, at 251, the synching map may comprise determining a synching map that is a subdivision of the “master” synching map, such as one of the individual synching maps. This may allow for improved efficiency of performance, as there would be a smaller list of mappings that processor(s) 141 would need to “look-up” when determining a corresponding data location of the second document format for the data location of the changed value.

In some embodiments, the individual synching maps may be determined from user input received by synching server 140 from application server(s) 110, 140 or user device(s) 120, 122. In some examples, synching server 140 may track which application server, user device or user that creates the individual synching map, by creating and using log data comprising information about each individual synching map. The log data may be transmitted to an application server, wherein the application server displays the “master” synching map graphically in the first application window, which shows each mapping (corresponding data location of the second document format) defined each individual synching map visually. For example, the data location of the first document format and the corresponding data location of the second document format may be highlighted using the same colour.

In some embodiments, synching server 140 may store log data comprising information about historical versions of the “master” synching map, which may correspond to changes in the individual synching maps, for example. The log data may be transmitted to application server(s) 110, 150 or user device(s) 120, 122 upon request from a user. The log data may comprise information about the “master” synching map or each individual synching map, such as, but not limited to, the user or device that create the individual synching map, which user or device removed the individual synching map from the “master” synching map and a timestamp of when an individual synching was created and/or added to the “master” synching map.

Synching server 140 determines, at 252, a first application synching configuration. The first application synching configuration comprises a set of data locations of the first document format. In some embodiments, determining at 252 the first application synching configuration in method 250 may comprises receiving the first application synching configuration from the processor(s) 111 of the first application server 110 or first user device 120, 122, corresponding to the processor(s) step 202 of method 200. In some embodiments, determining and/or receiving the first application synching configuration comprises determining and/or receiving the synching map comprising the first application synching configuration.

In some embodiments, determining the first application synching configuration comprises determining one of a plurality of predefined application synching configurations, each predefined application synching configuration comprising a different set of data locations of the first document format. As such, synching server 140 may determine or receive a plurality of predefined application synching configurations, for example, as may be created by application server(s) 110, 150 or user device(s) 120, 122. Each predefined application synching configuration may resemble a “template”, where a user may need different application synching configuration (templates) for different purposes. But rather than creating an application synching configuration each time, a user can create one or more application synching configurations and store them on synching server 140 or in a database accessible to synching server 140 for later use. Further, this application synching configuration may be shared with and used by other users.

In some embodiments, there may be one monolithic or “master” application synching configuration stored in data memory 145 of synching server 140 that is used to monitor or watch data locations of a first document format of a first document on application server(s) 110, 150 or user device(s) 120, 122. In some embodiments, similar to the “master” synching map, the “master” application synching configuration may be a combination of individual application synching configurations that each comprise a different set of data locations of the first document format. In some examples, the individual application synching configurations may be the predefined application synching configurations, above described above.

In some embodiments, the “master” application synching configuration may be displayed graphically on application server(s) 110, 150 or user device(s) 120, 122, for which each individual application synching configuration may be displayed graphically. For example, the data locations of one application synching configuration may be highlighted in one colour and the data locations of a different application synching configuration may be highlighted by a different colour. Application server(s) 110, 150 or user device(s) 120, 122, may also display information relating to the application server, user device or user that created an individual application synching configuration.

In some embodiments, synching server 140 determines corresponding data locations of the second document format for each of the set of data locations of the first document format, from the synching map. In some embodiments, synching server 140 may use the synching map in conjunction with one another to determine the data locations of the second document format that correspond to the set of data locations of the first document format. In an example, the synching map may specify a mapping for each data locations of the first document format to one or more data locations in the second document, but the first application synching configuration only specifies a subset of data locations of the first document. In other words, Synching server 140 may not require all the information from the synching map as the synching map may contain information about data locations that are not part of the set of data locations specified by the first application synching configuration.

In some embodiments, synching server 140 determines all or most of the corresponding data locations of the second document format for each of the set of data locations of the first document format, from the synching map. In some embodiments, synching server 140 determines corresponding data locations of the second document format for each of the set of data locations of the first document format, (and vice versa) from the synching map as required. For example, once it is determined that a change in value has occurred at a first data location, synching server 140 may use the synching map to determine the corresponding second data location in the second document.

Synching server 140 determines, at 254, a changed value at a data location of the set in one of the first document (or the second document). For example, synching server 140 may receive a first notification from the first application notifying of the change in value at a data location in the first document on first application server 110. In another example, synching server 140 may monitor for changes in the first document and determines 254 a changed value at a data location of the set in one of the first document. In a further example, synching server 140 may receive a second notification from the second application notifying of the change in value at a data location in the second document on first application server 110. In another example, synching server 140 may monitor for changes in the second document and determine a changed value at a data location of the set in one of the second document.

Synching server 140 determines, at 255, the data location of or associated with the changed value, and/or the respective or corresponding data location of the second document (or first document). For example, if synching server 140 receives a first notification from the first application, synching server 140 may determine, at 255, the corresponding data location of the second document corresponding to the data location of the first document specified by the first notification, using the synching map. In a similar example, if synching server 140 receives a second notification from the second application, synching server 140 may determine, at 255, a data location of the first document corresponding to the data location of the second document specified by the second notification, using the synching map stored. In other embodiments, the first and/or second notifications received from the first and/or second applications may comprise the corresponding data location to the data location where the change was made. For example, in such embodiments, the first and/or second applications servers and/or user devices may have access to a current state of the synching map and may determine therefrom the corresponding data location in the document generated by the other application.

Synching server 140 transmits, at 256, a third notification to the second application (or first application), responsive to determining a changed value at a data location of the set in the first document (or the second document). In some embodiments, the third notification comprises the data location of the second document (or the first document) and the respective changed value. In some embodiments, the third notification comprises the data location of the first document (or the second document) and the respective changed value. In such embodiments, the first and/or second applications servers and/or user devices may have access to a current state of the synching map and may determine therefrom the corresponding data location in the document generated by that application.

As an example, synching server 140 may determine a changed value at a data location of the set in the first document, and may transmit a notification to the second application, the notification comprising the data location of the second document and the respective changed value. In this example, in response to receiving the notification, processor(s) 111 of application server(s) 110, 150 or user device(s) 120, 122 executing the second application to generate the second document, may replace a current value at a data location of the second document with the changed value. In other words, synching server 140 may “look-up” the data location of the first document specified by the notification in the synching map. Synching server 140 may then determine the data location in the second document that corresponds to the data location of the first document, and may instruct application server(s) 110, 150 or user device(s) 120, 122 to replace the current value of the data location of the second document with the changed value of the data location of the first document. In this sense, the value at the data location of the first and second document are synchronised.

As such, the embodiments of method 250 provide methods for data synchronisation between a first application and a second application. This allows the first and second applications to interoperate, even if the first and second application are different software applications.

However, the first and second application may also be the same software application and, as such, the first and second document format may be the same, but the first and second document may be different and separate document files.

The described embodiments provide a further advantage as the first application may be software that is more familiar to a user, but the second application needs to be used. As an example, the first application may be Microsoft Excel and the second application may be an accounting application, wherein the data in both applications may correspond to accounting data. In this example, a user may be more familiar with Microsoft Excel, however the user must use the second application as the second application may be configured to perform accounting specific calculations. As such, the user may input data at a data location into a first document on Microsoft Excel and this data can be synched with the accounting application using the embodiments of methods 200 and 250. While the second application is an accounting application in the example, both the first and second applications may be accounting applications and the data synched between the two applications may correspond to accounting data.

In some embodiments, responsive to determining a changed value at a data location of the set in the other one of the first document or the second document, synching server 140 transmit a second notification to the first or second application, respectively, wherein the second notification comprises the data location of the other one of the first or second document and the respective changed value. For example, the one of the first document or the second document may be the first document, therefore the other of the first document and the second document would be the second document. Simply put, determining a change in one document may cause synching server 140 to transmit a notification to the other document, thereby establishing bi-directional synching between the two documents of the two applications.

In some embodiments, synching server 140 may determine an updated application synching configuration. For example, the updated application synching configuration may comprise an updated or revised set of data locations of the first document format or the second document format. In some embodiments, updated application synching configuration may be received from the first user device 120 or application server 110 executing the first application or from application server 150 executing the second application. In some embodiments, synching server 140 may determine, from the synching map, the corresponding data locations of the second document format or the first document format, for one or more, or all of the set of data locations of the first document format or the second document format, respectively, of the updated application synching configuration. In some embodiments, this may be performed on an ad hoc basis, as needed when values at data locations of the revised or updated set change.

Synching server 140 may, responsive to determining a changed value at a data location of the set of the application synching configuration in the first document or the second document, transmit a third notification to the second or first application. The third notification may comprise the changed value and at least one of: (i) the data location of the first or second document; and (ii) the corresponding data location of the first or second document associated with the changed value.

In some embodiments, determining and/or receiving the updated application synching configuration comprises determining and/or receiving an updated synching map comprising the updated application synching configuration (i.e., updated data location in one document) and a corresponding data location in the other document for each of the updated data locations of the set of data locations in the updated application synching configuration.

Synching server 140 may transmit the updated application synching configuration and/or the updated synching map to the other application, that is, the first or second application other than the application with which the change in configuration or synching map was made.

In some embodiments, the updated application synching configuration may correspond to a change in the first application synching configuration. The change may be responsive to user input. For example, a user may add a new data location to the set of data locations by selecting the data location of a user interface presented on a user device. Similarly, a user may remove a data location from the set of data location by deselecting a selected data location. In some embodiments, the user may specify the data locations to be added or removed from the set of data locations by inputting the data fields corresponding to the data locations using the user interface presented on the user device.

In some embodiments, upon determining a change in the first application synching configuration, for example, on receiving an updated application synching configuration (from the first application or from the second application), synching server 140 may replace the first application synching configuration with the updated application synching configuration.

It is noted that there may be a plurality of predefined application synching configurations, each predefined application synching configuration comprising a different set of data locations of the first document format. Synching server 140 may determine a change in one of the predefined application synching configurations on application server(s) 110, 150 or user device(s) 120, 122 and may update the corresponding application synching configuration accordingly. Updating the corresponding application synching configuration accordingly may comprise processor(s) 111 of application server(s) 110, 150 or user device(s) 120, 122 transmitting the updated application synching configuration to synching server 140. Similar embodiments may occur for a plurality of predefined synching maps.

In the embodiment where there are a plurality of predefined application synching configurations, processor(s) 141 may label each application synching configuration, in order to distinguish the application synching configuration from each other. As an example, the predefined application synching configurations may be represented by a JSON file and the processor(s) may automatically label the file name with a unique file identifier, such as a document ID, for example. In another example, processor(s) 141 may include a label in the JSON file itself, rather than modifying the file name. In another example, processor(s) 111 of application server(s) 110, 150 or user device(s) 120, 122 may receive user input which specifies a label of the application synching configuration. The user may label a predefined application synching configuration, such that the application synching configuration is recognisable by the user or can be recognised by another user. In some embodiments, application program interfaces (APIs) for the first and/or second application may be used to store the predefined application synching configurations on synching server 140 and processor(s) 111 of application server(s) 110, 150 or user device(s) 120, 122 may retrieve a predefined application synching configuration to modify and/or update the synching configuration, using the APIs and the document ID.

Similar embodiments may occur for a plurality of predefined synching maps.

In some embodiments, processor(s) 111 or 141 may determine an updated synching map on the first or second application and, in response to determining the updated synching map, processor(s) 111 may transmit the updated synching map to the other application and/or the synching server. Synching server 140 may determine an updated synching map by determining a change in the synching map on the first or second application. As an example, processor(s) 111 may receive user input indicative of a change in the mapping between a data location in the first document format and a data location in the second document format.

In some embodiments, synching server 140 transmits a subscription request to the first application and/or the second application, wherein the subscription request comprises a subscription for notification of a change in any of the data locations of the first application synching configuration. For example, the subscription request may be an event notification request. Synching server 140 may transmit the subscription request to an application server of user device in response to receiving a first application synching configuration from an application server or user device, for example.

Where bidirectional synching is desired, for example, synching server 140 may use the first application synching configuration to determine the data locations of the second document and may transmit a subscription request to the second application server (or user device executing the second application) to subscribe to changes in values at the respective data locations.

In some embodiments, synching server 140 may use the log data to “undo” a change in the data location of the first or second document format, responsive to receiving a notification, the second notification comprising an identified data location of the first document format and an updated value. For example, synching server 140 may determine a change in the data at a data location in the first application, which may cause a change in a current value at a data location in the second application, as determined by the application synching configuration and the synching mapping. This change may be “undone” using the second application as the change is logged in the log data. As a result, the value at the data location in the second application may be replaced with the value at the data location before the synching server 140 determined a change in the first application. The change in the data in the second application may then be automatically mapped to the corresponding data location in the first application as determined by the synching map. In this sense, it would appear that the first change determined on the first application never happened. Similar embodiments would occur between a first application on first user device 120 and a first application on first user device 122, wherein a changes cause by one device can be “undone” on the other device, using the log data.

The log data may also provide a user with information, such as, but not limited to, the state of the document when it was first opened compared to the state of the document at a later point in time during the current session, and changes that a user has made to the document during the current session.

In some embodiments, log data associated with changes to values at data locations in documents may comprise one or more of: a data location identifier; a document identifier; a value (for example, the changed value at the data location); a user identifier.

It may be important to record the document identifier in situations where multiple different documents (for example, multiple different Excel spreadsheets) are linked to the same common document (for example, a specific Workbook) to be able to determine from which document caused a particular change in value. It may be important to record the user identifier in situations where multiple users have the ability to cause the change in value being propagated through to the document.

In some embodiments, when data is synched between documents, information about changed values at data locations of the set may be stored as an event log in an event store accessible to synching server 140. The event log may also comprise information about mapping(s) 431, 432, 471, for example. Synching server 140 may hash the information in the event log using a hash function to create a hash value corresponding to the event log information. For example, the hash function may be the SHA-256 hashing function, however any hashing function may be used. As such, the event log may comprise a hash value and a timestamp, for example, corresponding to the time that the event occurred.

In some embodiments, there may be an internal change detection flow that operates using a locking mechanism to ensure only one change is made at a time. This may ensure there are no conflicting changes during the synchronisation of data between the first documents 413, 453 of the first applications 411, 451 and/or the first documents 413, 453 and second documents 414, 454 respectively. In some examples, synching server 140 may compare event logs to ensure there are no conflicting changes to the data being synched between documents. In some embodiments, synching server 140 may compare the hash values of the event logs as identical data may produce identical hashes, whereas different data may produce very different hashes. If the hash values between two event logs do not match, synching server 140 assumes that the more recent timestamp is correct and may synch the data according to the most recent event log.

For example, synching server 140 may receive two notifications from first application server 110 that correspond to changes in the values of the same data locations. As such, synching server 140 may create an event log corresponding to each notification and compare the hash value of each event log. Synching server 140 may then accept the event log with the most recent timestamp, if the hash values of the notification do not match. Synching server 140 may then transmit a notification to first application server 110, corresponding to the accepted event log.

In embodiments where a document is being deleted by an application server and/or user device, or subscriptions to particular locations are otherwise required to be removed, synching server 140 may utilise the GUID of the document to identify all data locations being watched for that particular GUID and cancel the subscriptions/watches.

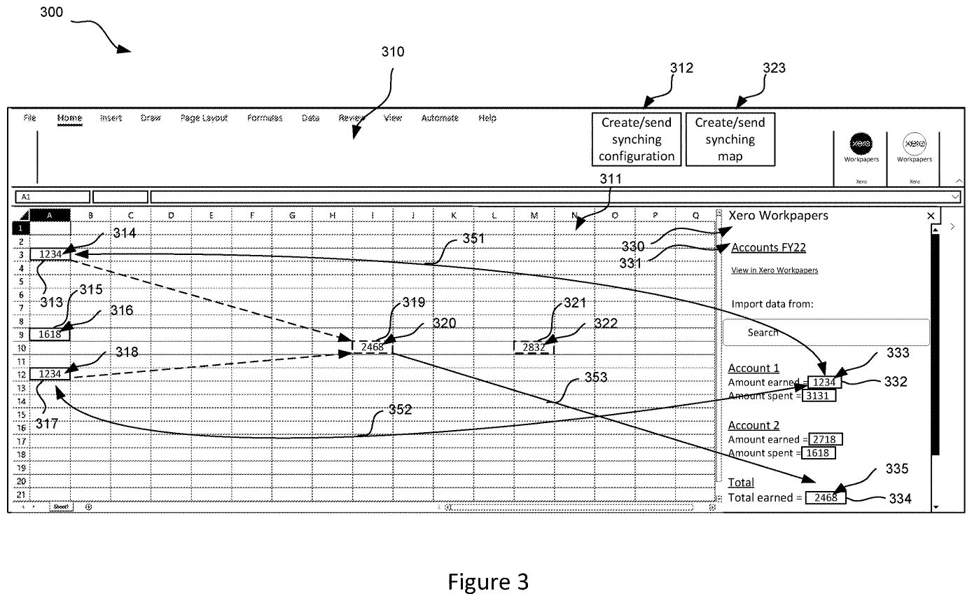

FIG. 3 illustrates an example of user interface 300 for data synchronisation between a first application 310 and a second application 330, according to some embodiments. In this example, user interface 300 may executed by first application server 110 or may be executed and displayed on first user device 120. For explanatory purposes, user interface 300 will be executed by first application server 110. In this example, first application 310 generates a first document 311, which is a spreadsheet comprising multiple rows and multiple columns. The multiple rows and multiple columns define a plurality of cells, and each cell corresponds to a data location of the first document 311. Further, second application 330 generates a second document 331. In this example, first application 310 and second application 330 are different types of applications.

Further, in this example, second application 330 is an add-on extension to first application 310, as such, second application 330 can be seen in the first application window of first application 310. In other words, second application 330 is presented in a widget or element embedded within the first application window of the user interface 300.

An example of generating an application synching configuration will now be explained using FIG. 3. In this example, a user may provide input to first application server 110 and interact with synching configuration button 312, which causes first application server 110 to initialise the creation of an application synching configuration. The user may then select data locations 313, 315, 317 of the first document format of first document 311, wherein data locations 313, 315, 317 contain values 314, 316, 318 respectively. Data locations 313, 315, 317 correspond to the set of data locations of a first document format of a first document 311 generated by the first application 310. Therefore, data locations 313, 315, 317 correspond to data locations (in this example, cells of the spreadsheet) that the user would like to monitor or watch for changes in values 314, 316, 318. FIG. 3 also shows data locations 319, 321 which contain values 320, 322 respectively, which the user does not select during the creating process, hence data locations 319, 321 will not be part of the set of data locations in the application synching configuration (as represented by the dashed cell box). The user may then interact with synching configuration button 312 again, which terminates the process of creating an application synching configuration. After creation, application synching configuration may be stored locally on first application server 110, transmitted to synching server 140 and/or sent to a database over communications network 130.

In another example of creating an application synching configuration, a user may interact with synching configuration button 312 to begin the process of creating an application synching configuration, and the user may select a data location such as data location 313. In response to the user selecting data location 313, first application server 110 may generate the application synching configuration and transmit the configuration, without the user interacting with the synching configuration button 312 again. The user may then select another data location, such as data location 315, which would correspond to a change (or update) in the application synching configuration. First application server 110 may determine the change in the application synching configuration and may generate an updated application synching configuration, which the server may store locally or transmit to synching server 140. First application server 110 may store the updated application synching configuration by replacing the configuration that was initially created. Synching server 140 may similarly replace the configuration it first received with the updated configuration. After the user has selected all the data locations to be monitored or watched, the user may interact with synching configuration button 312 again to terminate the creation process. As such, after the user interacts with this button for a second time, first application server 110 will not create an update configuration or transmit the configuration to synching server 140.

In the above example, after an application synching configuration creation process has terminated, the user may begin a new creation process to create a new synching configuration by interacting with the synching configuration button 312. In this new process, first application server 110 may generate a new application synching configuration, but will not replace the configuration that was created by the previous creation process.

An example of generating a synching map will now be explained using FIG. 3. In this example, a user may provide input to first application server 110 and interact with synching map button 323, which causes first application server 110 to initialise the creation of a synching map. The user may then select data location 313 in the first document format of the first document.

The user may then select data location 332 in the second document format of the second document 331 on the second application 330. Selecting data location 313 in first application 310 and data location 332, which contains value 333, in second application 330 defines mapping 351, wherein mapping 351 is to be specified by the synching map being created. The user may also have the option to decide whether mapping 351 is a bidirectional mapping. For example, if mapping 351 was a bidirectional mapping, a change to value 314 at data location 313 would transmit a notification to second application and may change value 333 at data location 332 and vice versa. However, if mapping 351 was a unidirectional mapping, a change in value 314 may cause a change in value 333, but a change in value 333 may not cause a change in value 314.

In this example, the user may define another mapping by selecting another data location in first application 310 and another data location in the second application 330. For example, after defining mapping 351, the user may select data location 317 then select a data location in second application 330. For example, the user may also select data location 332, to define mapping 352. As such, there may be multiple mappings in the synching map that map to the same data location.

The user may then interact with synching map button 323 again to terminate the process of creating a synching map. First application server 110 may then store the synching map or transmit the synching map to synching server 140. Similarly to creating an application synching configuration, an updated synching map may be created by defining new mappings during the creation process, and the first application server 110 may store or transmit the updated synching map after determining an updated map.

It is noted that user may select data locations to be monitored or watched, however one or more of the selected data locations may not have a mapping from first application 310 to second application 330. For example, during the creation of an application synching configuration, user may select data location 315 in the first document format of first document 311. However, a particular synching map stored on the first application server 110 may not contain a mapping from data location 315 to a data location in the second document format of second document 331. Similarly, the syncing map may define a mapping from a data location in first document 311 that is not in the set of data locations specified by the application synching configuration.

For example, the synching map may specify mapping 353, however data location 319 may not be part of the set of data locations specified by the particular synching configuration stored on first application server 110.

In some embodiments, first application server 110 may be configured to retrieve an application synching configuration or a synching map from local storage or from storage on synching server 140, for example. First application server 110 may be further configured to edit the application synching configuration or synching map. As an example, first application server 110 may retrieve an application synching configuration stored on synching server 140, and a user may edit the configuration by interacting with synching configuration button 312. The user may then select new data locations or unselect data locations to create a new set of data locations in the first document format of first document 311. The user may then interact with synching configuration button 312 to terminate the editing process and the updated synching configuration may be transmitted to synching server 140. In some embodiments, a user may edit a synching map by a similar process.

In some embodiments, first application 310 may have value watching functionalities, that may be used in conjunction with the embodiments of the method and system describe herein. For example, a user may specify a function applied to value 320 at data location 319 in the first document format of first document 311 using the functionality of first application 310. For example, the function may add value 314 at data location 313 with value 318 at data location 317 to determine value 320. While addition of values is presented in this example, more complicated functions with various mathematical operations may be used, if it is within the functionality of first application 310. For example, if first application 310 was Microsoft Excel, the function may be any combination of different mathematical operations. Further, while two data location are used in this example, many more data locations may be used in the function.

In the above embodiment, an application synching configuration may specify data location 319 in the set of data location in the first document format of first document 311.

Further, a synching map may define mapping 353 from data location 319 to data location 334 in the second document format of second document 331. As a result, a change in value 314 may change value 320 as dictated by the function within first application 310, which will transmit a notification to second application 330 and may cause a change to value 335.

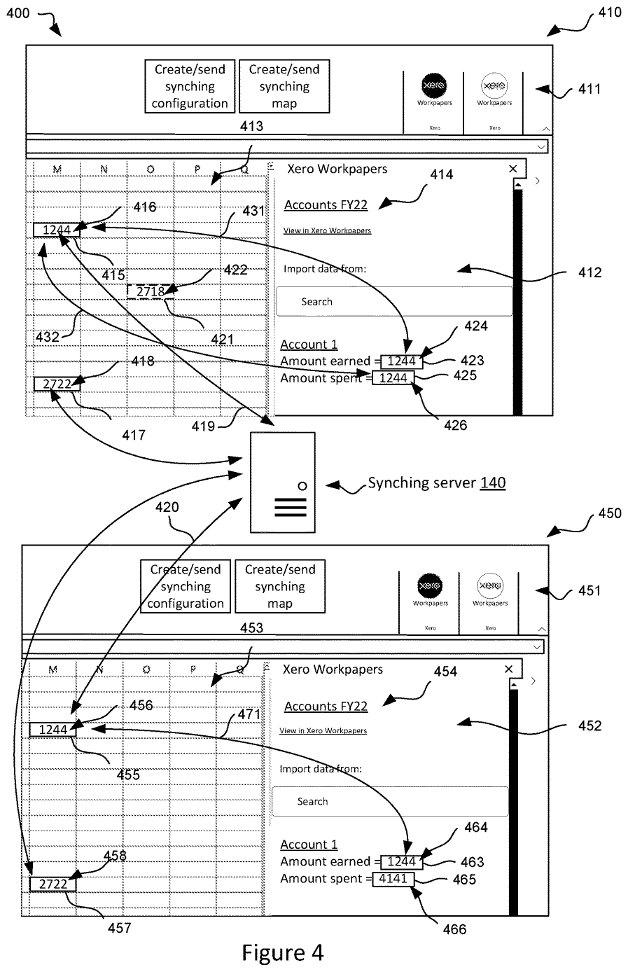

FIG. 4 illustrates an example of system 400 for data synchronisation between a first user interface 410 and a second user interface 450, according to some embodiments. In this example, first user interface 410 may be generated by first application server 110 and second user interface 450 may be generate by second application server 150. However, it is noted that either user interface may be generated on a compatible device, such as an application server or a user device. In some embodiments, both user interfaces may be generated on the same device, by using two virtual machines, for example.

In another example, each user interface may be generated on the same device using two separate application windows, such as two separate windows of an internet browser application, two separate windows of a device compatible application (such as a desktop, iOS or Android application) or a window of each (i.e., one internet browser application window and one device compatible application window). In some embodiments, one of the two user interfaces may be generated on a compatible device in an application window, such as an internet browser application or device compatible application and the other user interface may be generated on another compatible device in an application window. For example, first user interface 410 may be generated by a desktop application on a desktop computer and second user interface 450 may be generate by mobile application on a mobile device.

Both user interfaces may run a first application and a second application. Specifically, in this example, first user interface 410 comprises first application 411 and second application 412, with first document 413 and second document 414. Second user interface 410 comprises first application 451 and second application 452, with first document 453 and second document 454. In this example, both first documents are spreadsheets and both second applications are add-on extensions, thereby being present in the first window of each first application. In this example, an application synching configuration and/or synching map may be created, retrieved, edited by a user via either user interface, as described in the embodiments above.

In the following example, consider that both application servers have received a subscription request from synching server 140 according to a particular application synching configuration available to synching server 140. As such, synching server 140 is subscribed to be notified of changes in the first and/or second documents on either application server.

In this example, the application synching configuration may specify data locations as the set of data locations of a first document format of a first document. As such, changes in the corresponding values 416, 418 will cause first application server 110 to transmit first notification 419 to synching server 140, wherein first notification 419 comprises the data location and the respective changed value. In some embodiments, synching server 140 monitors and/or watches for changes in the data locations, and determines a change without first application server 110 transmitting first notification 419. Data locations 455, 457 in first document 453 of second application server 150 correspond to the same locations within the first document format as data locations 415, 417, as determined by the synching server from the synching map. As such, in response to receiving first notification 419 from first application server 110 or synching server 140 determining a change at the data location, synching server 140 determines the respective data location in the second document 454 and transmits second notification 420 to second application server 150, the second notification 420 comprising the determined data location (i.e., data location 455 or 457) of the second document format and an updated value. Upon receiving second notification 420, second application server 150 may replace a current value at the identified data location (i.e., data location 455 or 457) with the updated value.

Further, in this example, as synching server 140 has determined a change in value 416, 456, synching server 140 determines the corresponding data location in the second document using the syncing map, and transmits a second notification including the value and corresponding location to the first application server 110 and second application server 150. First application server 110 receives the second notification and may replace value 416 accordingly. Similarly, second application server 150 receives the second notification and may replace value 456 accordingly. As such, the embodiments of the methods and system described herein enable bidirectional synchronisation of data values between two devices. Simply put, as both application servers have the same application synching configuration and are configured for bi-directional data synchronisation, values 416 and 456 (values 418 and 458) will be the same value, thereby synching these values across the application servers.

Data location 421 may be a data location in the first document format of first document 413 that is not part of the set of data locations specified by the application synching configuration. As such, changes to value 422 will not cause first application server 110 to transmit a notification to synching server 140 or synching server 140 will not determine a change. This is depicted in FIG. 4, as there is no corresponding data location in the first document on user interface 450.

In this example, synching server 140 may, using the synching map accessible to the synching server 140, define mapping 431 that maps data location 415 to data location 423 in second application 412. Equivalently, synching server 140 defines mapping 471 that maps data location 455 to data location 463 in second application 452. As such, a change in value 416, for example, would cause synching server 140 to transmit a notification to second application 412, the notification comprising data location of second document 414, according to the synching map stored on synching server 140, and the respective changed value. Simply put, a change in value 416 may cause the same change to value 424. In this example, the same process would occur on second application server 150, hence a change in value 456 may cause the same change to value 464.

Further, in this example, a change in value 424 may cause synching server 140 to transmit a notification from first application 411, the notification comprising data location of first document 414, according to the synching map stored on synching server 140, and the respective changed value As such, the embodiments of the methods and system described herein enable bidirectional synchronisation of data values between two application, even if the two application are different application types.

In this example, synching server 140 may be subscribed to changes on both application servers, according to an application synching configuration, stored on synching server 140.

However, in another example, synching server 140 may be subscribed to changes on first application server 110, according to a first application synching configuration, while synching server may be subscribed to changes on second application server 150, according to a second application synching configuration. As such, synching server 140 may determine changes on the first application server 110, but will not transmit a notification to second application server 150.

In this example, synching server 140 may be subscribed to changes on both application server, according to an application synching configuration and a synching map, stored on synching server 140. However, in another example, synching server 140 may be subscribed to changes on first application server 110, according to a first synching map, while synching server may be subscribed to changes on second application server 150, according to a second synching map.

For example, synching server 140 may, using the synching map stored on synching server 140, define mapping 431 and/or 432, wherein mapping 432 maps data location 415 to data location. As such, a change in value 416 may cause a change to value 456 on second application server 150 according to the application synching configuration stored on synching server 140.

However, as the first synching map defines mapping 432, the change in value 416 may cause a change in value 426. However, as the second synching map does not specify the same mapping as mapping 432, value 466 at data location 465 may not change in response to a change in value 456.

In some embodiments, a user may interact with either user interface, which may cause the respective application server to transmit a notification to synching server 140 and/or from the first application to the second application on the respective application server, without synching server 140 determining a changed value at a data location specified by the application synching configuration stored on synching server 140. For example, the user may select a data location 421 in the first document format of first document 413 on first application 411, which may cause first application server 110 to transmit a notification to synching server 140, wherein the notification comprises the selected data location 421 and value 422. If synching server 140 is subscribed to changes on both application servers, then synching server 140 may transmit the notification to second application server 150. The user may also specify whether, upon second application server 150 receiving the notification, to replace the current value at the data location in the first document on second application server 150, or whether to simply notify the second application server 150 in the form of a message or “pop-up” notification, for example. It is noted that the user may select data location 421 and cause first application server 110 or synching server 140 to transmit the notification, despite data location 421 not being part of the set of data locations specified by an application synching configuration.

In some embodiments, similar to the previously discussed embodiments, a user may transmit a notification from a first application to a second application without synching server 140 determining a change in the value at the data location and/or without a mapping from the data location to a data location in the second application. For example, the user may select data location 457, then they may select data location 465. This may cause synching server 140 to transmit a notification from first application 451 to second application 452, wherein the notification comprises data location 457 and value 458. The user may also specify whether, upon second application receiving the notification, to replace the current value at data location 465, or whether to simply notify second application 452 in the form of a message or “pop-up” notification, for example.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1.-12 (canceled)

13. A method comprising:
determining a synching map, the synching map comprising a set of data locations of a first document format, and for each of a plurality of data locations, a corresponding data location of a second document format,
wherein the first document format is associated with a first document generated by a first application, and the second document format is associated with second document generated by a second application, and wherein the first application is different to the second application;
determining a first application synching configuration, the first application synching configuration comprising a set of data locations of the first document format; and
responsive to determining a changed value at a data location of the set of data locations in the first document, transmitting a first notification to the second application, wherein the first notification comprises the changed value and at least one of: (i) data location of the first document; and (ii) a corresponding data location of the second document.

14. The method of claim 13, further comprising:
responsive to determining the changed value at the data location of the set in the first document, determining, from the synching map, the corresponding data location of the second document, wherein the first notification comprises the corresponding data location determined from the synching map.

15. The method of claim 13, or further comprising:
responsive to determining a changed value at a data location in the second document, the data location corresponding to a data location of the set in the first document, transmitting a second notification to the first application, wherein the second notification comprises the changed value and at least one of: (i) the corresponding data location of the first document associated with the changed value; and (ii) the data location of the second document associated with the changed value.

16. The method of claim 15, further comprising:
responsive to determining the changed value at the data location of the set in the second document, determining, from the synching map, the corresponding data location of the first document, wherein the second notification comprises the corresponding data location determined from the synching map.

17. The method of claim 13, further comprising:
determining an updated application synching configuration, the updated application synching configuration comprising an updated set of data locations of the first document format or the second document format; and
responsive to determining a changed value at a data location of the set in the first document or the second document, transmitting a third notification to the first or second application, respectively, wherein the third notification comprises the changed value and at least one of: (i) the data location of the first or second document; and (ii) the corresponding data location of the first or second document associated with the changed value.

18. The method of claim 13, further comprising:
determining, from the synching map, the corresponding data location of the first or second document.

19. The method of claim 17, wherein determining an updated application synching configuration comprises receiving the updated application synching configuration from the first application or the second application.

20. The method of claim 13, wherein determining the first application synching configuration comprises determining one of a plurality of predefined application synching configurations, each predefined application synching configuration comprising a different set of data locations of the first document format.

21. The method of claim 13, wherein the first and second applications are different types of applications.

22. The method of claim 13, further comprising:
transmitting a subscription request to the first application and/or the second application, wherein the subscription request comprises a subscription for notification of a change in any of the data locations associated with the first application synching configuration.

23. The method of claim 13, further comprising:
transmitting the first application synching configuration to the second application; and
responsive to a changed value at a data location of the set in the second document being determined by the second application, receiving a message comprising the data location and the changed value.

24. The method of claim 23, wherein transmitting the first application synching configuration to the second application comprises transmitting the synching map including the first application synching configuration to the second application.

25. The method of claim 13, further comprising storing, in an event log, information about changed values at data locations of the set.

26. The method of claim 13, wherein the first and/or second document comprises a spreadsheet,
wherein the spreadsheet comprises multiple rows and multiple columns, the multiple rows and multiple columns defining a plurality of cells, and
each cell corresponding to a data location of the first and/or second document.

27. The method of claim 13, wherein
the first and/or second application is an accounting application and the data corresponds to accounting data.

28. The method of claim 13, wherein the set of data locations of the first document format or the second document format is a subset of all data locations of the first document format or the second document format respectively.

29. The method of claim 13, further comprising determining the synching map or determining the first application synching configuration using a user input via a user interface of one or more user interfaces.

30. A system comprising:
one or more processors; and
memory comprising computer executable instructions, which when executed by the one or more processors, cause the system to perform operations including:
determining a synching map, the synching map comprising a set of data locations of a first document format, and for each of a plurality of data locations, a corresponding data location of a second document format,
wherein the first document format is associated with a first document generated by a first application, and the second document format is associated with second document generated by a second application, and wherein the first application is different to the second application;
determining a first application synching configuration, the first application synching configuration comprising a set of data locations of the first document format; and
responsive to determining a changed value at a data location of the set of data locations in the first document, transmitting a first notification to the second application, wherein the first notification comprises the changed value and at least one of: (i) data location of the first document; and (ii) a corresponding data location of the second document.

31. A non-transient computer-readable storage medium storing instructions that, when executed by a computer, cause the computer to perform operations including:
determining a synching map, the synching map comprising a set of data locations of a first document format, and for each of a plurality of data locations, a corresponding data location of a second document format,
wherein the first document format is associated with a first document generated by a first application, and the second document format is associated with second document generated by a second application, and wherein the first application is different to the second application;
determining a first application synching configuration, the first application synching configuration comprising a set of data locations of the first document format; and
responsive to determining a changed value at a data location of the set of data locations in the first document, transmitting a first notification to the second application, wherein the first notification comprises the changed value and at least one of: (i) data location of the first document; and (ii) a corresponding data location of the second document.
